(19) United States
(12) Patent Application Publication
(10) Pub. No.: US 2008/0199749 A1
(43) Pub. Date: Aug. 21, 2008

(54) ORGANIC ANODES FOR HYDROCARBON FUEL CELLS

(75) Inventor: Xiaoyi Gong, Ponca City, OK (US)

Correspondence Address: ConocoPhillips Company I.P. Legal, P. O. Box 2443, Bartlesville, OK, 74005, US

(73) Assignee: CONOCOPHILLILPS COMPANY, Houston, TX (US)

(21) Appl. No.: 11/676,182

(22) Filed: Feb. 16, 2007

(51) Int. Cl. H01M 4/00

(52) U.S. Cl. 429/27

(57) ABSTRACT

Novel anodes for hydrocarbon fuel cells are described herein. Embodiments of the anode incorporate free radical initiators to facilitate the electro-chemical reaction kinetics at the anode in hydrocarbon fuel cells. In an embodiment, an anode for a hydrocarbon fuel cell comprises an electrically conductive substrate. The anode further comprises a layer comprising a free radical initiator. The layer is applied to the electrically conductive substrate. In addition, methods of making the anodes are disclosed.

### FIELD OF THE INVENTION

The present invention relates generally to fuel cells. More specifically, the present invention relates to anodes for hydrocarbon fuel cells.

### BACKGROUND OF THE INVENTION

Fuel cells have received increased attention recently, because of their potential for high efficiency and low pollution. Fuel cells are electrochemical devices that convert the chemical energy of a reaction directly into electrical energy. In a typical fuel cell, a gaseous fuel is fed continuously to the anode and a gaseous oxidant is fed continuously to the cathode. The chemical reactions at each electrode produce a flow of ions between the electrodes, resulting in an electrical current that can then be used to power other devices.

At present, most fuel cell technology has been developed for fuel cells that consume hydrogen. Hydrocarbons are much more readily available for use as fuel than is hydrogen, however, hydrogen fuel cells require the use of a fuel reformer upstream to accommodate hydrocarbon fuels. The fuel reformer converts hydrocarbons into hydrogen, but the additional equipment and process steps required increase the cost and decrease the efficiency of the system overall. Previous hydrocarbon fuel cells have also tended to have low power density and/or require prohibitive amounts of expensive catalysts. Therefore, it would be advantageous to provide a fuel cell that could operate efficiently using hydrocarbon fuels directly.

Alternatively, prior art solid oxide fuel cells (SOFCs) can utilize hydrocarbons directly via internal or external reforming. In this approach, a hydrocarbon fuel (e.g., methane) is combined with H₂O and/or CO₂, which are typically obtained by recirculating the fuel cell exhaust, and introduced directly to the SOFC anode. Commonly used Ni-based anodes provide the catalyst for the endothermic reforming reactions. However, maintaining appropriate gas composition and temperature gradients across a large area SOFC stack is challenging. See, Janssen, G. J. M., DeJong, J. P., and Huijsmans, J. P. P. Internal reforming in state-of-the-art SOFCs. 2nd European Solid Oxide Fuel Cell Forum, 163-172, Ed. by Thorstense, B. (Oslo/Norway, 1996); and Hendriksen, P, V., Model study of internal steam reforming in SOFC stacks. Proc. 5th Int. Symp. on Solid Oxide Fuel Cells, 1319-1325, Ed. by U. Stimming, S. C. Singhal, H. Tagawa, and W. Lehnert (Electrochem, Soc., Pennington, 1997).

For instance, if the reforming reactions are slow, then insufficient H₂ is supplied to the SOFCs. On the other hand, fast reforming reactions cause localized cooling near the fuel inlet, leading to poor cell performance, and possible cell fracture. Thus, current SOFC stacks known in the art do not take full advantage of internal reforming; rather, they employ a combination of approximately 75% external and 25% internal reforming of hydrocarbon fuels. See, Ray, E. R. Westinghouse Tubular SOFC Technology, 1992 Fuel Cell Seminar, 415-418 (1992). SOFCs can, in principle, operate by the direct electrochemical oxidation of a hydrocarbon fuel. This approach would be desirable since it may eliminate the problems with internal reforming mentioned above, and the theoretical maximum fuel efficiency is as good as or better than that for reforming. However, prior art attempts with SOFCs operating at temperatures in the range of T_{c}=900-1000° C. with methane fuel have been less than satisfactory: either power densities were very low or carbon deposition was observed. See, Putna, E. S., Stubenrauch, J., Vohs, J. M. and Gorte, R. J. Ceria-based anodes for the direct oxidation of methane in solid oxide fuel calls, Langmuir 11, 4832-4837 (1995); and Aida, T., Abudala, A., Ihara, M., Komiyama, H. and Yamada, K. Direct oxidation of methane on anode of solid oxide fuel cell. Proc. 4th kit. Symp. On Solid Oxide Fuel Cells, 801-809, Ed. By Dokiya, M., Yamamoto, O., Tagawa, H. and Singhal, S. C, (Electrochem. Soc. Pennington, 1995).

A fuel cell that takes hydrocarbons and directly converts chemical energy to electricity is ideal for several reasons. Firstly, the expensive fuel processing step, where a hydrocarbon is reformed to produce hydrogen, is eliminated with a hydrocarbon fuel cell as hydrocarbons are abundantly available in nature or can be easily processed from existing technologies. Moreover, the challenges of hydrogen storage and transportation are avoided with a hydrocarbon fuel cell. The primary limitation of hydrocarbon fuel cells is the slow oxidation reaction at the anode. Presently, anodes which have been traditionally used for hydrogen fuel cells have not been able to improve the kinetics of hydrocarbon oxidation at the anode.

Consequently, there is a need for anodes with improved anodic kinetics with hydrocarbon fuels.

### SUMMARY OF THE INVENTION

In an embodiment, an anode for a hydrocarbon fuel cell comprises an electrically conductive substrate. The anode further comprises a layer comprising a free radical initiator. The layer is applied to the electrically conductive substrate.

In another embodiment, a method of making an anode comprises providing a free radical initiator. The method further comprises mixing the free radical initiator with a liquid to form a mixture. In addition, the method comprises applying the mixture to an electrically conductive substrate to make the anode.

In yet another embodiment a hydrocarbon fuel cell comprises an electrolyte. The hydrocarbon fuel cell further comprises an anode having an electrically conductive substrate and a layer comprising a free radical initiator. The layer is applied to said electrically conductive substrate. The anode and the cathode are contact with the electrolyte.

### BRIEF DESCRIPTION OF THE DRAWINGS

For a more detailed description of the preferred embodiments of the present invention, reference will now be made to the accompanying drawings, wherein:

FIG. 1 is a plot of the potential-current density curve of heptene at the 40% platinum carbon black anode with the azobisisobutyronitrile (AIBN) free radical initiator; and

FIG. 2 is a plot of the potential-current density curve of heptene at the 40% platinum carbon black control anode without the AIBN.

### DETAILED DESCRIPTION OF THE PREFERRED EMBODIMENT

In a preferred embodiment, an anode for hydrocarbon fuel cells comprises a layer comprising a free radical initiator mixed with a catalyst, wherein the layer is applied to an electrically conductive substrate. As defined herein, a free radical initiator is any compound that is capable of producing free radicals to initiate a chemical chain reaction. Examples of free radical initiators that may be used include without limitation, peroxides, hydroperoxide, azonitrile, redox systems, persulfates, perbenzoates, and combinations thereof. In a specific embodiment, the free radical initiator is azoisobutyronitrile (AIBN) may preferably be used. However, the free radical initiator may comprise any initiator known to those of ordinary skill in the art.

The free radical initiator may be present in the anode in any suitable weight percentage. In an embodiment, the anode comprises a weight percentage in the range from about 20% to about 80%, preferably from about 30% to about 70%, more preferably in the range from about 40% to about 60%.

Without being limited by theory, it is believed that the presence of free radical initiators enhances or facilitates the electro-oxidation reaction at the anode. For example, AIBN when incorporated into the anode undergoes the following reaction:

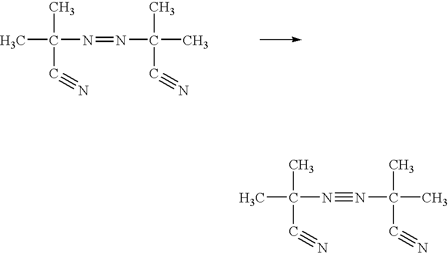

The resultant free radicals may initiate the oxidation reactions of the hydrocarbons. However, it is important to note that the free radical initiator does not participate in the initiation of any polymerization reaction in the anode, if present.

In embodiments, the catalyst may comprise any material known by those of ordinary skill in the art to catalyze electrochemical reactions. Examples of such materials include without limitation, platinum, chromium, palladium, nickel, ruthenium, and combinations thereof. According to a preferred embodiment, the catalyst is in powder form. In one embodiment, the catalyst may be coated onto an electrically conductive compound. For instance, in a particular embodiment, the catalyst may comprise platinum-coated carbon black (PtCB).

According to at least one embodiment, the free radical initiator and the catalyst are applied to an electrically conductive substrate. In a preferred embodiment, the electrically conductive substrate comprises graphite. However, the electrically conductive substrate may comprise any suitable electrically conductive material known to those of skill in the art. Furthermore, in general, the substrate preferably comprises a flat or planar configuration. Alternatively, the substrate comprises other geometries, such as cylindrical, cuboidal, etc., without limitation.

In another embodiment, the free radical initiator may be plated to an anode. According to one embodiment, the anode comprises an alloy or metal incorporating the free radical initiator plated to an electrically conductive substrate. The alloy may comprise any combination of electrically conductive metals. Exemplary metals that may be combined to form the alloy include without limitation, platinum, palladium, gold, copper, nickel, steel, lead, ruthenium, and others known to those skilled in the art. In an embodiment, the alloy comprises a platinum-palladium alloy. The atomic ratio of platinum to palladium in the alloy may be from about 1/10 to about 10/1, preferably from about 1/3 to about 3/1, more preferably from about 1/2 to about 2/1.

In general, a variety of hydrocarbons may be used in conjunction with embodiments of the anode in a hydrocarbon fuel cell. In a particular embodiment, the hydrocarbon fuel is an alkene. However, it is envisioned that any suitable hydrocarbon may be used as fuel such as alkanes, alkenes, alkynes, aryls, etc., as would be known to one of skill in the art. Examples of suitable hydrocarbons include without limitation, hexene, hexane, heptane, heptene, propylcyclopentene, ethylcyclohexane, butene, butane, pentane, pentene and combinations thereof.

It is further envisioned that embodiments of the disclosed anode may be used in conjunction with any suitable hydrocarbon fuel cell known to those of skill in the art. Examples of suitable fuel cells include without limitation, solid oxide fuel cells, polymer electrolyte fuel cells, alkaline fuel cells, molten carbonate fuel cells, direct alcohol fuel cells, etc.

In a typical fuel cell, the anode and a cathode are in contact with an electrolyte. In an embodiment, the electrolyte is disposed between the cathode and the anode. The electrolyte may comprise any suitable material. Examples of suitable electrolytes include without limitation, a solid oxide, an alcohol, an acid, a molten carbonate, a polymer, etc. Furthermore, in an embodiment of a fuel cell, a fuel is flowed over or is in continuous contact with the anode. Through electrochemical reactions, a current is produced from the anode to the cathode, thus generating electricity.

In embodiments, the cathode may comprise any suitable material. Examples of suitable materials include without limitation, a metal, a polymer, a rare earth metal, an alloy, a composite, or combinations thereof.

In an embodiment, a method of making an anode comprises mixing an electrically conductive material and a free radical initiator to form a slurry. The electrically conductive material and the free radical initiator may be any of the compounds described above. In a specific embodiment, the electrically conductive material and the free radical initiator are first mixed to form a dry mixture. The mixture comprises at least about 10% by weight free radical initiator, preferably at least about 30% by weight free radical initiator, and more preferably at least about 50% by weight free radical initiator.

The mixture is then added to a polymer suspension to form a slurry. The polymer suspension comprises a solution of a polymer and a liquid. In at least one embodiment, the polymer is polytetrafluoroethylene (PTFE) and the liquid is deionized water. Furthermore, the suspension comprises at least about 1% by weight polymer, preferably 10% by weight polymer, more preferably 60% by weight polymer.

Once the slurry has been formed, it may be applied to or coated onto an electrically conductive sheet. The sheet is preferably a carbon containing material such as, by way of illustration only, carbon fiber paper. In an embodiment, the layer comprises carbon fiber paper reinforced or regularized with a substrate to provide support for the carbon fiber paper. The carbon fiber paper may be regularized to the substrate by gluing the paper to the substrate using an adhesive (e.g. carpenter's glue, cyanoacrylate, etc.). The substrate is typically made of graphite but, alternatively, may be made of any otherwise suitable electrically conductive material. In one embodiment, before application of the slurry, the carbon fiber paper is pre-wetted with a liquid to improve adhesion to the substrate.

The anode may comprise more than one layer or coating of the slurry. That is, once a first layer of slurry has been applied and has dried, another layer may subsequently be applied. In some embodiments, the anode may comprise up to five layers of slurry. Without being limited by theory, it is believed that the ending potential and the open circuit voltage become more negative with more layers of the slurry, thus improving the anodic performance of the anode.

In another embodiment, a method of making an anode comprises plating a substrate with an alloy and a free radical initiator The substrate is preferably made of an electrically conductive material (e.g. graphite). To plate the substrate, current is applied to the substrate in the presence of a plating solution. The current applied may range from about 1 mA to about 100 mA. Additionally, the current may be applied for any suitable period of time. According to one embodiment, the current is applied for a time period ranging from about 5 min to about 60 min.

In an embodiment, the plating solution comprises one or more metal salt solutions. Each metal salt solution contains the metal to be incorporated into the alloy anode. Typically, one of the metals is a catalyst. By way of example only, the plating solution may comprise a platinum salt solution and a palladium salt solution. However, the metal in the salt solution may be any electrically conductive metal, as described above. Typically, the metal in each salt solution comprises a concentration of from about 0.1% to about 1% by weight, preferably from about 0.25% to about 0.75% by weight, and more preferably from about 0.5% by weight. Moreover, any number of metal salt solutions may be mixed to form the plating solution, depending on the alloy desired in the anode.

In one embodiment, the plating solution comprises a solution of two metal solutions and the free radical initiator. The ratio of the two metal solutions in the plating solution may comprise a ratio ranging from about 1:3 to about 3:1. However, it is contemplated that the plating solution may comprise any suitable ratio of two metal solutions, as will be understood by those skilled in the art. Furthermore, the plating solution may comprise more than two metal solutions.

To incorporate the free radical initiator into the anode, the free radical initiator is mixed into the plating solution. In embodiments, the concentration of free radical initiator in the plating solution ranges from about 0.001 g/mL plating solution to about 0.1 g/mL plating solution. In at least one embodiment, a surfactant is added to the plating solution to emulsify the free radical initiator. Examples of suitable surfactants include without limitation, alkyl sulfate, polyethylene oxide, methyl cellulose, and combinations thereof.

### EXAMPLE 1

### Organic Composite Anode Preparation

An organic composite anode was constructed of four components: a graphite substrate, carbon paper, powder catalyst, and a free radical initiator. A dry mixture was prepared using 1 part platinum coated carbon black (PtCB) and 1 part AIBN. The dry mixture was mixed with an aqueous suspension of polytetrafluoroethylene and de-ionized water to make a slurry. For control anodes without AIBN, the PtCB was simply added to water to make the slurry.

Before application of the slurry, the carbon paper was regularized to the graphite substrate by spot-gluing the paper to the substrate using carpenter's glue. The slurry was then applied to the regularized carbon paper using a spatula. The slurry layer was dried in an oven at 50° C. After application and drying of the first layer of the slurry, a second layer of slurry was applied to the first layer. There was no difference in appearance superficially between the anode with and without AIBN. However, under a microscope, the AIBN organic anode exhibited structural domains of concavities and pits when compared to the anode without AIBN.

### EXAMPLE 2

### Organic Alloy Anode Preparation

Organic alloy anodes were prepared by incorporating AIBN into the alloy. A graphite substrate was plated with a mixture of 75 parts platinum salt solution and 25 parts palladium salt solution, with both solutions having the same concentration of 0.5% by weight. To plate the graphite substrate, electrical current was applied for 30 min at 50 mA current. To prepare the alloy anode with AIBN, AIBN was mixed in with the platinum-palladium plating solution. Alkyl sulfate was added to the plating solution to emulsify the AIBN. Under scanning electron microscopy analysis, the plated alloy anode was found to be homogeneous in composition.

### EXAMPLE 3

### Anode Testing

A half-cell was used to test the performance of the anode and electro-oxidation of the hydrocarbon fuels. The half cell used to test the anodes consisted of a 200 mL glass container, a potentiostate/galvanstat instrument, and three electrodes. The three electrodes: a working electrode, a counter electrode, and a reference electrode, were immersed in the glass container and connected to the potentiostat/galvanometer.

An aqueous electrolyte, potassium hydroxide, was mixed with a hydrocarbon fuel and added to the glass container. Testing was commenced by running a program installed on the potentiostat/galvanostat. During testing, electrical current was applied through the working electrode and counter electrode, while voltage between the working electrode and reference electrode was measured. The monitored working electrode potential was taken as the anodic potential.

Stepped current scanning was used to acquire the anodic potential in which the voltage was stabilized at a specific current and then allowed to fall to zero before the next current level. The anodic potential of the organic anode was compared to the anodic potential of a control anode (e.g. an anode without AIBN added). In addition, the Tafel slope was used to compare anodic performance. Tafel slope is the potential difference or voltage loss when current density is increased by one decade. The following equation defines and calculates the Tafel slope, b:

η=a+b log i

where η=potential and i=current density.

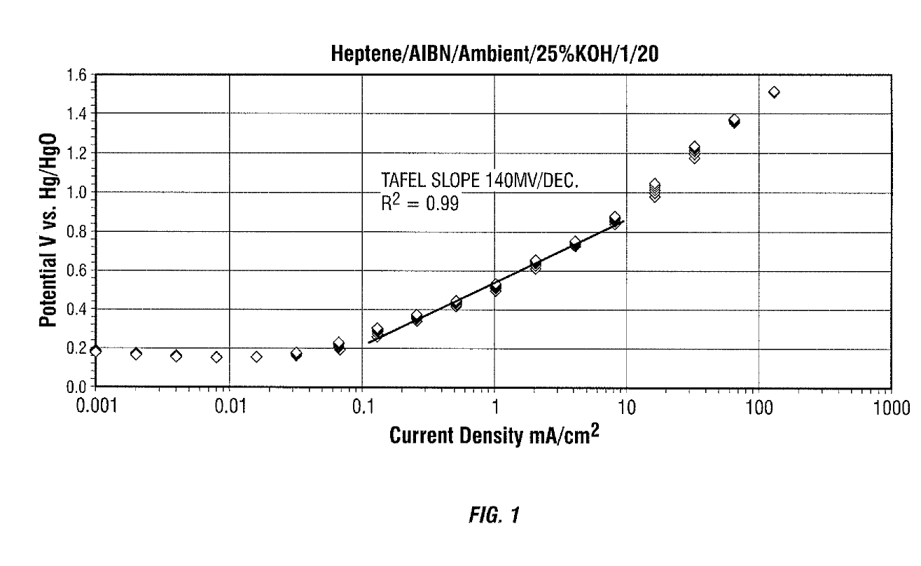

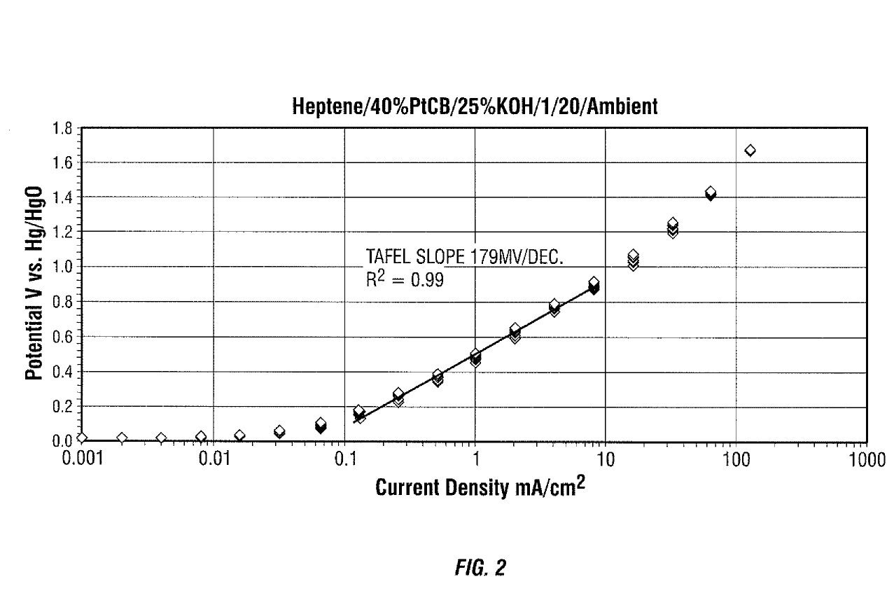

Tafel slope is particularly useful in characterizing electrodes because it is a parameter affected only by transfer polarization and is independent of electrical resistance, ionic concentration, and reversible reactions. The lower the Tafel slope, the better the performance of the anode. The results of Tafel slope and anodic potential are shown in Table 1 and FIGS. 1-2. The data indicate enhanced anodic performance of heptene with the free radical initiator anode when compared with a control composite anode without the free radical initiator.

| | | | Anodic Potential | |
|---|---|---|---|---|
| | | | (V vs. Hg/HgO) | |
| | Tafel Slope (mV/dec) | | | Control |
| Temperature | Organic Anode | Control Anode | Organic Anode | Anode |
| Ambient | 140 | 179 | 1.45 | 1.58 |
| 50° C. | 130 | 143 | 0.90 | 1.24 |
| 80° C. | 141 | 149 | 0.97 | 0.97 |

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

What is claimed is:

1. An anode for a hydrocarbon fuel cell comprising:
an electrically conductive substrate; and
a layer comprising a free radical initiator, wherein said layer is applied to said electrically conductive substrate.

2. The anode of claim 1 wherein said layer further comprises a catalyst.

3. The anode of claim 2 wherein said layer comprises a coating of said free radical initiator and said catalyst applied to an electrically conductive sheet, wherein said electrically conductive sheet is applied to said electrically conductive substrate.

4. The anode of claim 3 wherein said electrically conductive sheet comprises carbon fiber paper.

5. The anode of claim 3 wherein said electrically conductive sheet comprises a material capable of adhering to said coating.

6. The anode of claim 1 wherein said free radical initiator is selected from the group consisting of peroxides, hydroperoxides, azonitriles, redox systems, persulfates, perbenzoates, and combinations thereof.

7. The anode of claim 1 wherein said free radical initiator comprises azoisobutyronitrile.

8. The anode of claim 1 further comprising a plurality of said layers applied to said electrically conductive substrate.

9. The anode of claim 2 wherein said catalyst is a portion of an alloy.

10. The anode of claim 9 wherein said layer is plated on to said electrically conductive substrate.

11. The anode of claim 9 wherein said alloy comprises palladium and platinum.

12. The anode of claim 2 wherein said catalyst is coated onto carbon black powder.

13. The anode of claim 2 wherein said catalyst comprises carbon black coated with a metal selected from the group consisting of platinum, palladium, chromium, ruthenium, and combinations thereof.

14. The anode of claim 2 wherein said electrically conductive substrate comprises graphite.

15. The anode of claim 2 wherein said electrically conductive substrate comprises a metal.

16. The anode of claim 15 wherein said metal is selected from the group consisting of copper, gold, silver, nickel, iron, lead, and combinations thereof.

17. The anode of claim 1 wherein said electrically conductive substrate is porous.

18. The anode of claim 1 wherein said electrically conductive substrate is cylindrical.

19. A method of making an anode comprising:
a) providing a free radical initiator;
b) mixing the free radical initiator and a support material to form a mixture; and
c) applying the mixture to an electrically conductive substrate.

20. The method of claim 19 wherein the support material is carbon black.

21. The method of claim 19 wherein the support material is a catalyst.

22. The method of claim 21 wherein b) comprises mixing the free radical initiator and the catalyst in a suspension to form a slurry.

23. The method of claim 21 wherein the suspension comprises a polymer suspension.

24. The method of claim 22 wherein the polymer suspension comprises a concentration from about 1% by weight to about 60% by weight polymer.

25. The method of claim 22 wherein the polymer suspension comprises polytetrafluoroethylene.

26. The method of claim 22 wherein c) comprises attaching an electrically conductive sheet to the electrically conductive substrate and applying the slurry to the electrically conductive sheet.

27. The method of claim 25 wherein the electrically conductive sheet comprises carbon fiber paper.

28. The method of claim 25 wherein c) further comprises drying the slurry after applying the slurry to the electrically conductive substrate.

29. The method of claim 27 further comprising repeating c) to form a plurality of layers.

30. The method of claim 28 comprising repeating c) two to five times.

31. The method of claim 20 wherein the free radical initiator is selected from the group consisting of peroxides, hydroperoxides, azonitriles, redox systems, persulfates, perbenzoates, and combinations thereof.

32. The method of claim 20 wherein the catalyst is dissolved in a solvent to form a metal salt solution.

33. The method of claim 31 wherein b) comprises mixing the free radical initiator and the metal salt solution to form a plating solution.

34. The method of claim 32 wherein applying the mixture to an electrically conductive substrate in c) comprises immersing the substrate in the plating solution and applying a current to the substrate to plate the substrate with the free radical initiator and the catalyst so as to make the anode.

35. The method of claim 32 wherein b) comprises mixing the free radical initiator with more than one metal salt solution.

36. The method of claim 34 wherein a) comprises mixing the free radical initiator with two metal salt solutions.

37. The method of claim 35 wherein the two metal solutions are mixed in a ratio of 1:1.

38. The method of claim 32 wherein the plating solution is a salt solution containing about 0.5% by weight of the metal salt.

39. The method of claim 32 wherein the metal catalyst is selected from the group consisting of platinum, palladium, ruthenium, chromium, nickel, and combinations thereof.

40. The method of claim 33 wherein c) comprises applying an electrical current ranging from about 1 mA to about 100 mA.

41. The method of claim 33 wherein c) comprises applying an electrical current for a time period ranging from about 5 min to about 60 minutes.

42. A hydrocarbon fuel cell comprising:
an electrolyte;
an anode having an electrically conductive substrate and a layer comprising a free radical initiator, wherein said layer is applied to said electrically conductive substrate, wherein said anode is in contact with said electrolyte; and
a cathode in contact with said electrolyte.

43. The hydrocarbon fuel cell of claim 42 further comprising a hydrocarbon fuel in contact with said anode.

44. The hydrocarbon fuel cell of claim 43 wherein said hydrocarbon fuel is selected from the group consisting of hexene, hexane, heptane, heptene, propylcyclopentene, ethylcyclohexane, butene, butane, pentane, pentene and combinations thereof.

45. The hydrocarbon fuel cell of claim 42 wherein said layer further comprises a catalyst.

46. The hydrocarbon fuel cell of claim 45 wherein said layer comprises a coating of said free radical initiator and said catalyst applied to an electrically conductive sheet, wherein said electrically conductive sheet is applied to said electrically conductive substrate.

47. The anode of claim 45 wherein said catalyst is a portion of an alloy.

48. The anode of claim 47 wherein said layer is plated on to said electrically conductive substrate.

49. The hydrocarbon fuel cell of claim 42 wherein said electrolyte comprises a material selected from the group consisting of a solid oxide, a polymer, an alcohol, an acid, an alkaline, a molten carbonate, and combinations thereof.

50. The hydrocarbon fuel cell of claim 42 wherein said cathode comprises a material selected from the group consisting of a metal, a polymer, an alloy, a composite, a rare earth metal, and combinations thereof.
